(19) United States
(12) Patent Application Publication
(10) Pub. No.: US 2014/0290103 A1
(43) Pub. Date: Oct. 2, 2014

(54) SIGN AND SYSTEM FOR DISPLAY OF ENVIRONMENTAL CONDITIONS

(71) Applicant: ADCO INTERNATIONAL PTY LTD., Victoria (AU)

(72) Inventor: Bradley Robert KYBERD, Victoria (AU)

(73) Assignee: ADCO INTERNATIONAL PTY LTD., Victoria (AU)

(21) Appl. No.: 13/850,728

(22) Filed: Mar. 26, 2013

(51) Int. Cl. G09F 19/02

(52) U.S. Cl. CPC G09F 19/02
USPC 40/466; 40/463

(57) ABSTRACT

A sign (10) for display of an environmental condition, including a display portion including a front display surface (12) having at least one scale (16) indicating levels (16.1 to 16.6) of the environmental condition. At least one indicator (14) is provided which is movable over the scale (16) to provide a visual indication of a predetermined level (16.1 to 16.6) of the environmental condition. Control means (202 to 208) affixed to a rear surface of the display portion are provided for moving the indicator(s) (14) over the scale(s) (16). The control means (202 to 208) includes a remote device management module (202) which is controllable from a remote location (110, 120) over a communications network (100) to move the indicator(s) (14) to the predetermined level (16.1 to 16.6). The present invention also provides a kit for assembly of a sign (2010), such as, for example, for converting a manual sign (1010) into an automated sign (2010), and corresponding systems for display of environmental conditions.

### FIELD OF THE INVENTION

The present invention relates to signs and systems for display of environmental conditions.

### BACKGROUND OF THE INVENTION

In some locales, there is an increased risk of extreme environmental conditions such as fire or flooding. An important role for emergency services and other government agencies in such locales is to communicate extreme conditions to members of the public. For example, bushfires are a common occurrence in rural areas of Australia, and it is critical that fire authorities be able to warn the public of fire danger at times of high risk.

While information regarding fire or weather conditions is generally readily available to the public in urban areas, those resident in or travelling through more remote areas may not have access to such information. For this reason, local fire authorities in remote areas employ roadside fire danger rating signs to communicate the day's maximum fire danger level to passing motorists or pedestrians. Fire danger levels are generally forecast by meteorological authorities and are based on parameters such as seasonal dryness, amount and duration of rainfall, air temperature and relative humidity, and wind speed.

Known roadside fire danger rating signs include an indicator needle or arm pivotably attached to a board having a number of coloured segments, each of which corresponds to a different fire danger level, increasing in severity from left to right. The needle is manually moved on a daily basis to overlie the appropriate segment depending on that day's fire danger forecast. Once aligned with the appropriate fire danger rating segment, the needle is generally locked into position with a padlock to ensure that the correct fire danger rating is conveyed to the public at all times.

A problem with such existing manual fire danger rating signs is that the information they convey is totally reliant on the person or persons responsible for changing the position of the needle on a daily basis. Quite often such signs display incorrect fire danger ratings simply because they don't get changed. This problem is exacerbated in instances where signs are deployed in very remote locations.

It would be desirable to overcome or alleviate one or more problems of known fire danger rating signs, or at least to provide a useful alternative.

### SUMMARY OF THE INVENTION

In accordance with a first aspect of the present invention there is provided a sign for display of an environmental condition, including: a display portion including a front display surface having at least one scale indicating levels of the environmental condition; at least one indicator which is movable over the at least one scale to provide a visual indication of a predetermined level of the environmental condition; and, control means affixed to a rear surface of the display portion for moving the at least one indicator over the at least one scale; wherein the control means includes a remote device management module which is controllable from a remote location over a communications network to move the at least one indicator to the predetermined level.

Use of a communications network to control the indicator position permits the process of updating the status of the environmental condition to be conducted remotely and in an automated fashion. This can be done from a single location, as frequently as desired, and for more than one sign and/or scale. It is preferred that the communications network is a wireless data network, such as, for example, a cellular network.

In one embodiment, the scale(s) is/are an ordinal scale represented by a plurality of areas on the front display surface of the display portion, each area corresponding to one of the levels of the environmental condition. The areas may be segments of a semicircle which are preferably coloured.

Preferably, the indicator(s) is/are a needle. The needle may be rotatable about an axis perpendicular to a plane of the sign. Preferably, the needle is drivable by an electric motor. The control means may include drive means for driving the electric motor.

Preferably, the control means includes a programmable logic controller operably coupled to the remote device management module.

In one embodiment, the sign further includes a plurality of proximity switches, each proximity switch being associated with one of the plurality of areas, wherein the plurality of proximity sensors are used to determine the position of the at least one indicator or needle.

The environmental condition may be a fire danger rating. Alternatively, the environmental condition may be a flood or storm condition or the like.

The sign may further include an independent power supply. The independent power supply may include at least one photovoltaic panel and/or at least one wind turbine.

The sign may further include at least one electronic display means operably coupled to the control means. Advantageously, the display of data on the at least one electronic display means and the movement of the indicator(s) may both be carried out using the remote device management module. The at least one electronic display means may be configured to display data received over the communications network. The at least one electronic display means is preferably an LED display, but can be another type of electronic display, for example a liquid crystal display, OLED display, electroluminescent display or the like. The at least one electronic display means may be used for real-time display of messages related to the environmental condition, for example messages relating to detours which should be taken, areas which should be avoided and the like. The messages may also be unrelated to the environmental condition, and could contain, for example, advertising.

The programmable logic controller may store message data for display on the at least one electronic display means. The message data may be location-specific message data.

In a accordance with a further aspect of the present invention there is provided a computer system configured to connect to a communications network; computer-readable data storage in communication with the computer system; and, at least one sign according to any one of the preceding paragraphs; wherein the computer-readable data storage includes computer-readable instructions stored thereon which, when executed, cause the computer system to perform the steps of, for the or each said sign: receiving data representative of a predetermined level of the environmental condition; transmitting, over the communications network, instructions to the remote device management module to move the at least one indicator to the predetermined level.

In a accordance with yet a further aspect of the present invention there is provided a kit for converting a manual sign for display of an environmental condition to an automated sign for display of an environmental condition, the manual sign including a display portion having a front display surface with at least one scale thereon indicating levels of the environmental condition, the kit including: control means for affixing to a rear surface of the display portion of the manual sign; and, at least one indicator to be coupled to the control means through the display portion, the at least one indicator being movable over the at least one scale to provide a visual indication of a predetermined level of the environmental condition; wherein the control means includes a remote device management module which is controllable from a remote location over a communications network to move the at least one indicator to the predetermined level.

Preferably the at least one indicator is at least one needle, and wherein the at least one needle is rotatable about an axis perpendicular to a plane of the sign. Preferably the, or each, needle is drivable by an electric motor, and the control means includes drive means for driving the electric motor and a programmable logic controller operably coupled to the remote device management module for controlling the drive means.

The kit may further include a plurality of proximity sensors or switches used to determine the position of the at least one indicator or needle.

The environmental condition may be a fire danger rating. Alternatively, the environmental condition may be a flood or storm condition or the like.

The kit may further include an independent power supply. The independent power supply may include at least one photovoltaic panel and/or at least one wind turbine.

These and other essential or preferred features of the present invention will be apparent from the description that now follows.

### BRIEF DESCRIPTION OF THE DRAWINGS

In order that the invention may be more clearly understood and put into practical effect there shall now be described in detail preferred signs and systems for display of environmental conditions in accordance with the invention. The ensuing description is given by way of non-limitative examples only and is with reference to the accompanying drawings, wherein:

FIG. 1 shows an automated sign for display of environmental conditions, made in accordance with a first preferred embodiment of the present invention;

FIG. 2 is a block diagram of the preferred functional components of the automated sign of FIG. 1;

FIG. 3 is a schematic of a preferred indicator feedback circuit which is suitable for use with the automated sign of FIG. 1;

FIG. 4 shows a typical prior art fire danger rating sign, one which requires a person to manually move the indicator needle as required in order to convey fire danger warnings to the public;

FIG. 5 shows a control box component of a kit for assembly of an automated sign for display of environmental conditions, the kit being made in accordance with a further preferred embodiment of the present invention, the kit being suitable for converting a manual sign for display of environmental conditions, such as the manual fire danger rating sign of FIG. 4, into an automated sign, or for assembly of a new standalone automated sign for display of environmental conditions; and,

FIGS. 6 & 7 are side and rear views, respectively, of an automated sign for display of environmental conditions, the sign being assembled from and/or incorporating the control box component of FIG. 5, and other components of the kit for assembly of an automated sign for display of environmental conditions in accordance with the invention.

### DETAILED DESCRIPTION OF PREFERRED EMBODIMENTS

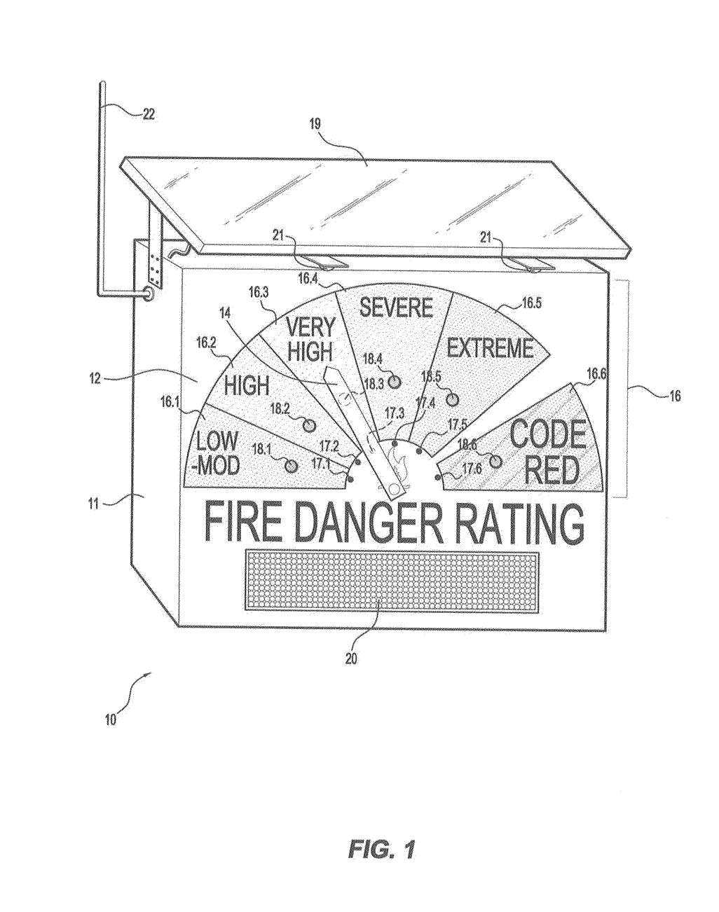

Referring initially to FIG. 1, there is shown a first preferred embodiment of an automated sign 10 for display of an environmental condition, the environmental condition in this example being fire danger rating. Although described hereinafter as being a sign 10 and related system for displaying a fire danger rating, it should be appreciated that signs and systems made in accordance with the present invention are not limited to that use only. The present invention should therefore not be construed as limited to the specific examples shown in the drawings.

Sign 10 generally includes a housing 11 having a front panel with a display surface 12. The display surface 12 includes at least one scale 16 comprising a plurality of areas, for example, a semi-circular scale 16 having six coloured areas 16.1 to 16.6 as shown, each area 16.1 to 16.6 being a predefined segment of the preferred semi-circular scale 16.

The plurality of areas 16.1 to 16.6 constitutes an ordinal scale 16 indicating levels of fire danger rating. The fire danger levels and their corresponding coloured segments are preferably as follows:
segment 16.1: low-mod (meaning, low-moderate fire danger rating);
segment 16.2: high;
segment 16.3: very high;
segment 16.4: severe;
segment 16.5: extreme; and,
segment 16.6: code red.

While an ordinal scale 16 having discrete levels for the environmental condition is shown in the embodiment of FIG. 1, it will also be appreciated that an interval scale, or a hybrid ordinal/interval scale, may be used if appropriate for the environmental condition that is to be displayed. The present invention should therefore not be construed as limited to the specific example provided.

Sign 10 preferably includes at least one indicator 14, preferably in the form of a needle 14, which can be moved over scale 16 to provide a visual indication of a predetermined level (for example, user-defined or computer-defined) of the environmental condition. For example, if needle 14 is moved to a position overlying segment 16.4, the predetermined fire danger level is “severe”. It will be appreciated that indicator means other than a needle 14 could also be used in accordance with the present invention. The specific form of indicator means being largely dependent on the form of scale or scales 16 provided on display surface 12.

Each of segments 16.1 to 16.6 preferably has associated with it one of a plurality of proximity sensors 17.1 to 17.6 (the position of proximity sensor 17.3 being obscured in FIG. 1 by needle 14). Proximity sensors 17.1 to 17.6 may be inductive proximity sensors which are triggered by a metallic portion of needle 14 (or by a metallic component attached to needle 14) as the metallic portion (or component) passes over them. Alternatively, they may be optical or infrared sensors which are triggered by changes in reflectance as needle 14 traverses the beam. A skilled person will appreciate many variations in sensors that could be used to determine the position of needle 14. Accordingly, the present invention should not be construed as limited to the specific examples provided.

Housing 11 of sign 10 may optionally also carry at least one electronic display means 20, preferably in the form of an LED display 20, but could be another type of electronic display, for example a liquid crystal display, OLED display, electroluminescent display or the like. LED display 20 may be used to display messages related to, or even completely independent from, the user/computer-defined level of the environmental condition, as will later be described. For example, LED display 20 could be used for real-time display of messages related to the environmental condition, for example messages relating to detours which should be taken, areas which should be avoided and the like. The messages may also be unrelated to the environmental condition, and could contain, for example, advertising.

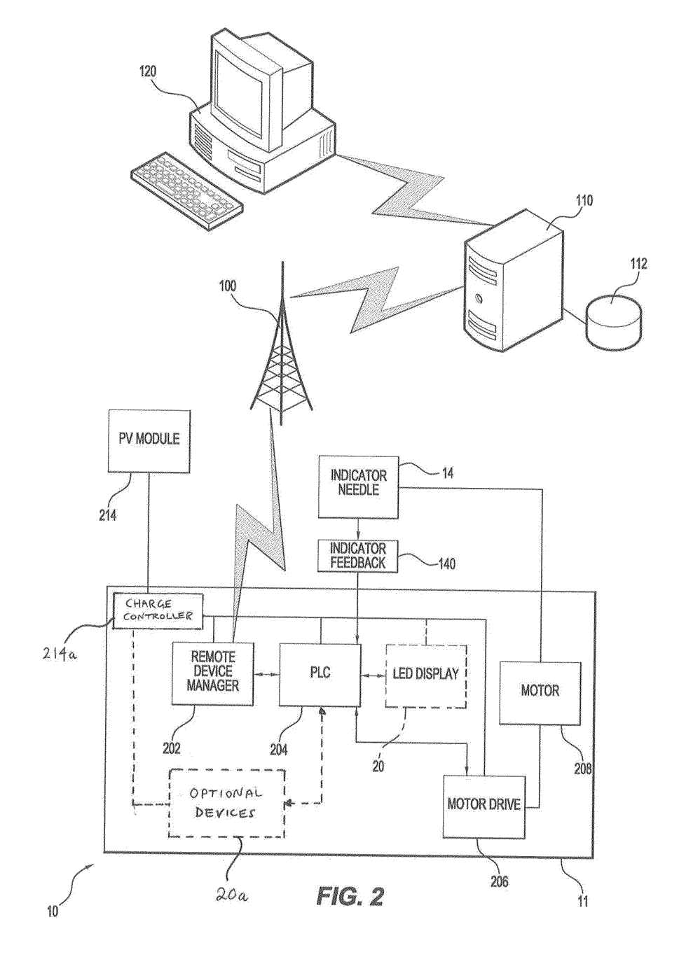

With reference now to FIG. 2, details of the preferred internal components of sign 10, and their relationship with indicator needle 14, scale 16, and optional LED display 20 are described. In order to indicate that LED display 20 of sign 10 is optional same is shown in dashed lines in FIG. 2.

Located within housing 11 of sign 10 are a remote device management module 202, a programmable logic controller (PLC) 204, a motor drive 206 and an electric motor 208 which is connected to, and is driven by, motor drive 206.

Remote device management module 202, PLC 204, and motor drive 206/motor 208 collectively form control means for indicator needle 14 of sign 10.

Electrical components of sign 10 are preferably powered by an independent power supply, which in the preferred embodiment shown in FIG. 2 is a photovoltaic module 214, but which may instead (or as well) include a wind turbine (not shown) or other alternative source of power (not shown).

Indicator needle 14 is coupled to an indicator feedback means 140, which is in turn coupled to PLC 204. Indicator feedback means 140 provides information to PLC 204 regarding the current position of indicator needle 14.

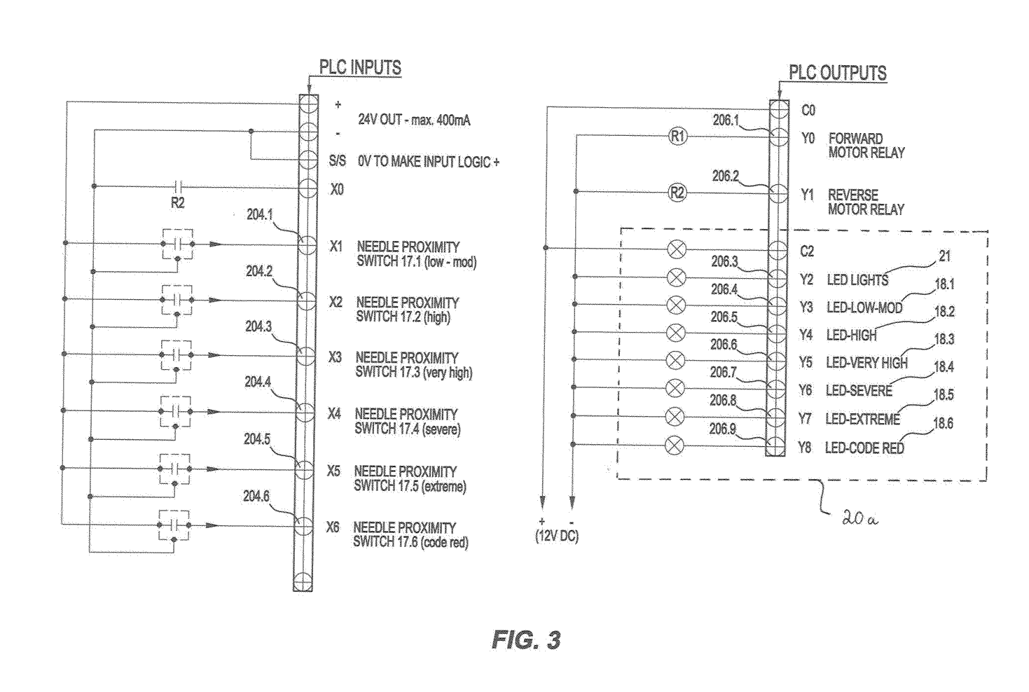

As shown in FIG. 3, indicator feedback means 140 includes proximity sensors 17.1 to 17.6 (FIG. 1) which are coupled to inputs 204.1 to 204.6 respectively of PLC 204. Each proximity sensor 17.1 to 17.6 is in electrical communication with a normally-open relay. Accordingly, when a proximity sensor 17.1 to 17.6 is triggered, its corresponding relay will close and this will be detected at the corresponding input of PLC 204, providing positional information to PLC 204.

If motor 208 is a stepper motor, indicator feedback means 140 (and hence, proximity sensors 17.1 and 17.6) may be omitted, since the number of pulses delivered to motor 208 is known a priori, and hence the position of needle 14 could be monitored by PLC 204 without needing feedback. In some embodiments, it may be advantageous to provide indicator feedback means 140 in conjunction with a stepper motor 208. For example, proximity sensors 17.1 and 17.6 could be provided at just the extremities of scale 16 (i.e. at segments 16.1 and 16.6) to monitor when needle 14 reaches either of those points, while the needle 14 position between the extremities could be monitored by counting the number of pulses delivered to stepper motor 208.

Photovoltaic module 214 includes a photovoltaic panel 19 which is located external to housing 11 of sign 10 as shown in FIG. 1, and a photovoltaic charge controller 214a of known type which may be housed within, partially within, or provided external to housing 11 of sign 10. The charge controller 214a preferably includes two 12 volt batteries (not shown) which are charged by current generated by photovoltaic panel 19. Photovoltaic module 214 is connected to and provides power to each of remote device management module 202, PLC 204, motor drive 206/motor 208, and optionally to LED display 20 and/or other optional devices 20a (see, for example, FIGS. 2 & 3, discussed later).

PLC 204 may be any suitable PLC, however those manufactured by Fatek Automation Corp have been found to be particularly well suited to the present embodiment, such as, for example, PLC model numbers FBs-24MCR-D12 or FBs-14MC, each of which include an RS485 port and an RS232 port. The RS485 port is preferably used to interface PLC 204 with remote device management module 202, which may be any suitable device, such as, for example, a Netbiter (registered trade mark) EasyConnect EC220 unit manufactured by Intellicom Innovation AB. Similarly, the RS232 port is preferably used to interface PLC 204 with optional LED display 20 and/or other optional devices 20a (discuss later). It will be appreciated that any suitable remote device management module 202 and PLC 204 could be used in accordance with the present invention. Accordingly, the present invention should not be construed as limited to the specific example provided.

Remote device management module 202 includes a network interface (not shown), preferably a wireless network interface (not shown), such as, for example, a GSM/GPRS modem coupled to aerial 22 (see, FIG. 1) which permits remote device management module 202 to communicate over a suitable communications network 100, such as, for example, a cellular telephone network 100. Thus, for example, remote device management module 202 can receive instructions from (and/or relay information to) a computer system 110 located at a remote location in order to drive components of sign 10 (and/or to provide feedback to computer system 110).

Computer system 110 is preferably a server computer system 110 in communication with computer-readable data storage 112. Computer-readable data storage 112 may be used to store the current position of indicator needle 14 of sign 10. It will also be appreciated that indicator position data for multiple signs 10 can be stored simultaneously. Alternatively, PLC 204 of sign 10 (or of each sign 10, if there is more than one) may store the indicator position data, and communicate the indicator position data to server computer system 110 via remote device management module(s) 202 and communications network 100.

Server computer system 110 may be configured to receive incoming network connections (either wired or wireless) from a client computer system 120, such that a user at client computer system 120 can interact with remote device management module 202 via server computer system 110 and communications network 100. Server computer system 110 and/or client computer system 120 may be any suitable computing device, such as, for example a desktop computer device, a notebook computer, a tablet, and/or a mobile or cell device, such as, for example, a smart phone.

To set the indicator position (needle 14 position) of sign 10, server computer system 110 first receives status data representative of the current level of the environmental condition from client computer system 120, or instructions to alter the indicator position from client computer system 120. The status data may be generated based on input of information relating to the current level by a user of client computer system 120 into a user interface. Alternatively, the data representing the current level may be retrieved from another server computer system (not shown), responsible for maintaining the status data, for server computer system 110 without requiring manual input.

Once the status data or instructions are received, server computer system 110 translates the data/instructions to a position along the scale 16 on display surface 12 of sign 10, and sends a request to remote device management module 202, via communications network 100, to move indicator needle 14 to that position. Optionally, server computer system 110 may compare the position to the current (stored) position of indicator needle 14 to determine, prior to sending the request, if any movement is needed at all, and if so, in which direction the indicator needle 14 should be moved. Alternatively, this comparison may be performed by PLC 204.

For example, suppose that indicator needle 14 is currently at segment 16.2, indicating that the current fire danger level is “high”. If it is desired to update the fire danger level to “extreme”, server computer system 110 requests (via communications network 100) remote device management module 202 to instruct PLC 204 to move needle 14 forward to segment 16.5 (from segment 16.2). PLC 204 closes a normally-open forward motor relay coupled to one of its outputs 206.1, which is also coupled to motor drive 206, thereby actuating motor 208 such that it moves in the forward direction (i.e., to the right in FIG. 1). PLC 204 keeps the forward motor relay closed until it detects, via indicator feedback means 140, that indicator needle 14 has triggered proximity sensor 17.5 (coupled to input 204.5) of segment 16.5. Similarly, if it was then desired to move the indicated fire danger level back to “low-moderate”, server computer system 110 would request movement of indicator needle 14 in reverse to segment 16.1 (from segment 16.5), resulting in PLC 204 closing a normally-open reverse motor relay coupled to another of its outputs 206.2 (which is also coupled to motor drive 206). PLC 204 then keeps the reverse motor relay closed until it detects, again via indicator feedback means 140, that indicator needle 14 has triggered proximity sensor 17.1 (coupled to input 204.1) of segment 16.1.

As discussed above, if motor 208 is a stepper motor, the position of indicator needle 14 can be monitored by PLC 204 without needing feedback. Accordingly, if the initial position of indicator needle 14 is known, the number of pulses required to be delivered to motor 208 to move needle 14 in either the forward or reverse direction to the desired position along scale 16 can be calculated (for example, by PLC 204). The triggering of proximity sensors 17.1 to 17.6 could be used as a cross-check if desired.

Should indicator needle 14 fail to move at all, or fail to move to the desired segment 16.1 to 16.6 of scale 16, PLC 204 (via indicator feedback means 140, and hence, proximity sensors 17.1 to 17.6) will determine that sign 10 has malfunctioned. Similarly, should server computer system 110 fail to communicate with sign 10, via remote device management module 202 and communications network 100, computer server system 110 will readily determine that sign 10 has malfunctioned. In such instances, feedback in the form of, for example, an e-mail, text message (short or multimedia message service, i.e. “SMS” or “MMS” message), or indication provided by way of the user interface installed on server computing system 110 and/or client computer system 120, may be sent to server computer system 110 and/or client computer system 120 to inform a user that sign 10 has malfunctioned. Thereafter, for example, a user of client computer system 120 could then take appropriate action to rectify the operation of sign 10. Alternatively, an e-mail, text message, etc., could be sent by server computer system 110 to an appropriate external organisation responsible for servicing sign(s) 10. It will be appreciate that feedback could also be provided to server computer system 110 and/or client computer system 120 by sign 10 in a similar fashion should other components of sign 10 fail, such as, for example, LED display 20 and/or other optional devices 20a (discussed later). A skilled person will appreciate these and other ways in which feedback could be provided, or otherwise ascertained, from sign 10 in accordance with the present invention. The present invention should therefore not be construed as limited to the specific examples provided.

Preferred LED display 20 may display a variety of messages. These may be conveyed from server computer system 110 (either directly, or after receipt of instructions from client computer system 120) to remote device management module 202, via communications network 100, which in turn sends instructions to PLC 204 to display message data on LED display 20. Remote device management module 202 may substantially simultaneously instruct PLC 204 to move indicator needle 14 to a predetermined position on scale 16, and to display a message on LED display 20. The message may be correlated with the predetermined position on scale 16. For example, if indicator needle 14 is pointing to segment 16.6, LED display 20 might simultaneously display a message “CODE RED: evacuate area immediately”, which may scroll across LED display 20.

Messages displayed on LED display 20 may be location-specific depending on the geographical position of sign 10. For example, if a particular road is known to be in a densely tree-populated area, LED display 20 may be instructed by PLC 204 (upon receipt of instructions from server computer system 110 and/or client computer system 120) to display a message to the effect that the road should be avoided. Location-specific messages may be stored on PLC 204, or alternatively may be stored in a database which is in communication with server computer system 110. In times of low to moderate fire danger, LED display 20 may be used to display advertisements or any other form of message as desired.

To improve the effectiveness and/or visibility of sign 10 (or scale 16), particularly at night or at times during which light conditions are poor, as can be seen in FIG. 1, sign 10 may also optionally include additional lighting components (“optional devices” 20a in FIGS. 2 & 3). For example, each of segments 16.1 to 16.6 of scale 16 may include at least one LED segment light 18.1 to 18.6 for illuminating a respective segment 16.1 to 16.6 corresponding to the position of needle 14. This illumination of a segment 16.1 to 16.6 serves as an additional means for passing motorists, etc., to easily determine the position of needle 14, and hence the relative fire danger level. As can be seen in FIG. 3, LED segment lights 18.1 to 18.6 are preferably coupled to outputs 206.4 to 206.9 of PLC 204, and are illuminated when required by the detection of the position of indicator needle 14 by a respective proximity sensor 17.1 to 17.6 coupled to PLC inputs 204.1 to 204.6. In a preferred form, each of LED segment lights 18.1 to 18.6 may be coloured to suit the colour of segments 16.1 to 16.6 of scale 16. For example, segments 16.5 (“extreme”) and 16.6 (“code red”) may each be coloured red, hence each of LED segment lights 18.5 and 18.6 may be red LED lights (or have red diffusers associated therewith) to correspond to those red segment colours 16.5, 16.6. Similarly, green, blue, yellow and orange colours may apply to segments 16.1 to 16.4, respectively, meaning matched coloured LED segment lights 18.1 to 18.4 (or diffusers, etc.) could be provided if desired. Sign 10 may also include a plurality of display surface illumination lights 21 (FIG. 1), such as, for example, suitable white or clear LED lights 21. Display surface illumination lights 21 are preferably coupled to output 206.3 of PLC 204 and may be illuminated: at all times; at times when light conditions are poor or at night; or at selected times as instructed by server or client computer systems 110, 120. To readily illustrate that LED segment lights 18.1 to 18.6, and display surface illumination lights 21, are optional devices or components of sign 10, in FIGS. 2 & 3 same are referred to as “optional devices” 20a, and are illustrated by a box shown in dashed lines.

Although not shown in the drawings, sign 10 may also include other optional devices 20a, such as, for example, a surveillance camera(s) (not shown) and/or a weather monitoring module (not shown). A surveillance camera(s) could be utilised to monitor attempts to tamper with sign 10, and/or to monitor traffic or nearby site conditions relative to sign 10. A weather monitoring module could be utilised to monitor site weather conditions, either for the purpose of the operation of sign 10 (i.e. in connection with fire danger ratings), or for providing weather conditions to external parties for other purposes. A skilled person will appreciate these and further optional devices that could be utilised in connection with sign 10 in accordance with the invention. The present invention should therefore not be construed as limited to the specific examples provided, and should be construed as including within its scope any suitable devices that could be readily added to sign 10 in accordance with the teachings of the description and/or the skilled persons general knowledge.

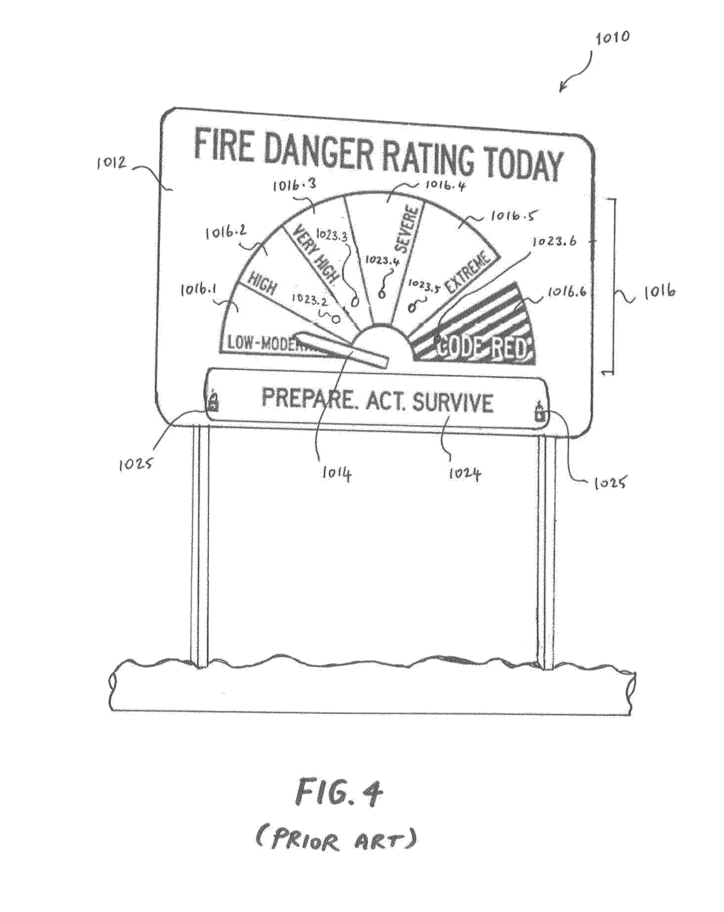

In FIG. 4 there is shown a typical prior art fire danger rating sign 1010, one which requires a person to manually move the indicator needle as required in order to convey fire danger warnings to the public. In FIG. 4 like reference numerals to those used to describe preferred automated sign 10 of FIGS. 1 to 3 are used to denote like parts of manual fire danger rating sign 1010 (hereinafter simply referred to as “sign 1010”). For example, indicator needle “14” of sign 10 of FIGS. 1 & 2 is referred to as indicator needle “1014” in FIG. 4, and so on.

As can be seen in FIG. 4, sign 1010 includes an indicator needle 1014 which can be manually pivoted with respect to the display surface 1012 of sign 1010 and the fire danger rating scale 1016 (with segments 1016.1 to 1016.6) provided thereon. Needle 1014 typically includes an integral protruding stud relative to its pivot point which passes through a hole (not shown) provided in display surface 1012, which enables a bolt or a padlock (both not shown) to be used to maintain needle 1014 connected to sign 1010 when required. In use, needle 1014 of sign 1010 is manually moved on a daily basis to overlie the appropriate segment 1016.1 to 1016.6 depending on that day's fire danger forecast. Once aligned with the appropriate fire danger rating segment 1016.1 to 1016.6, needle 1014 is generally locked into position with a padlock (not shown) to ensure that the correct fire danger rating is conveyed to the public (via segments 1016.1 to 1016.6, or scale 1016) at all times. To enable needle 1014 to be locked in position relative to segments 1016.1 to 1016.6, of scale 1016, each of segments 1016.1 to 1016.6 typically has associated with it one of a plurality of holes or slots 1023.1 to 1023.6 (the position of hole 1023.1 being obscured in FIG. 4 by needle 1014), and needle 1014 has an integral protruding stud in alignment with holes 1023.1 to 1023.6, which stud passes through a respective hole 1023.1 to 1023.6 and enables a padlock (not shown) to be used to maintain needle 1014 connected to sign 1010 as desired.

Also shown in FIG. 4 is a display board 1024 attached to sign 1010 for conveying additional information to the public. Display board(s) 1024 may be selectively attached to sign 1010 as desired, and are typically secured thereto by way of padlocks 1025. Display board(s) 1024 function is a similar (although far less sophisticated) fashion to that of optional LED display 20 of sign 10 of FIGS. 1 to 3.

As already outlined earlier, a problem with such existing manual signs 1010 is that the information they convey is totally reliant on the person or persons responsible for changing the position of the needle 1014 on a daily basis. Quite often such signs 1010 display incorrect fire danger ratings simply because they don't get changed. This problem is exacerbated in instances where signs 1010 are deployed in very remote locations.

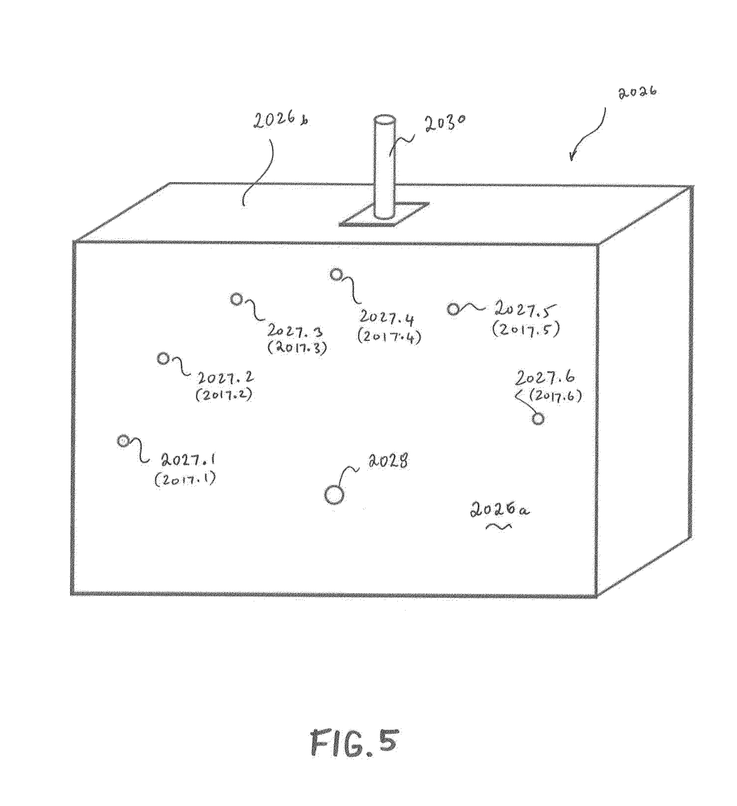

In FIGS. 5 to 7 there is shown a preferred embodiment of a kit for assembly of an automated sign 2010 for display of an environmental condition, the environmental condition again being fire danger rating. Although described hereinafter as being a kit for assembly of a sign 2010 and related system for displaying a fire danger rating, it should be appreciated that kits, signs and systems made in accordance with the present invention are not limited to that use only. The present invention should therefore not be construed as limited to the specific examples shown in the drawings. In FIGS. 5 to 7 like reference numerals to those used to describe preferred automated sign 10 of FIGS. 1 to 3 are used to denote like parts of kit and sign 2010. For example, indicator needle “14” of sign 10 of FIGS. 1 & 2 is referred to as indicator needle “2014” in FIGS. 5 to 7, and so on.

As will be described hereinafter in further detail, in accordance with a preferred embodiment of the present invention the kit of FIGS. 5 to 7 is suitable for converting a manual sign for display of an environmental condition, such as the manual fire danger rating sign 1010 of FIG. 4, into an automated sign 2010. That is, the kit of FIGS. 5 to 7 can be retrofitted to existing manual signs 1010 for converting those signs into automated signs 2010 that operate in the same or similar fashion to that of sign 10 of FIGS. 1 to 3. Although shown and described as being particularly suited for conversion of manual signs, it will be appreciated that new standalone automated signs 2010 can also be assembled in accordance with the present invention, utilising the kit of FIGS. 5 to 7, along with other typical sign components. The present invention should therefore not be construed as limited to the specific “retrofit” examples provided.

In FIG. 5 there is shown a control box component 2026 (hereinafter simply referred to as “control box 2026”) of the kit for assembly of an automated sign 2010 in accordance with the invention. On the front surface 2026a of control box 2026 there is provided a series of holes 2027.1 to 2027.6, each of which are configured to align with a respective hole (not shown in FIGS. 5 to 7, but which are shown as holes 1023.1 to 1023.6 in FIG. 4) provided on display surface 2012 of sign 2010. That is, for example, hole 2027.1 of control box 2026 is configured to align with the hole provided in the first segment (not shown), e.g. “Low-Mod” or “Low-Moderate”, of the scale (not shown) provided on display surface 2012 of sign 2010, and hole 2027.2 of control box 2026 is configured to align with the hole provided in the second segment, e.g. “High”, of the scale provided on display surface 2012 of sign 2010, and so on up to hole 2027.6 of control box 2026 relative to the sixth and final segment, e.g. “Code Red”, of the scale of the display surface 2012 of sign 2010.

Referring back to manual sign 1010 of FIG. 4, in conjunction with control box 2016 of FIG. 5, it should be apparent from FIG. 5 and the explanation provided in the preceding paragraph, that holes 2027.1 to 2027.6 of control box are configured to align with the holes 1023.1 to 1023.6 provided on display surface 1012 of manual sign 1010 that would otherwise be used to secure needle 1014 to manual sign 1010 by way of a padlock (not shown) as previously discussed.

Now turning back to FIG. 5, also provided on the front surface 2026a of control box 2026 is a hole 2028 (or motor drive shaft, not shown, but which will be discussed in further detail below) which is configured to align with a hole (not shown in FIGS. 5 to 7) provided on display surface 2012, of sign 2010, for provision of needle 2014.

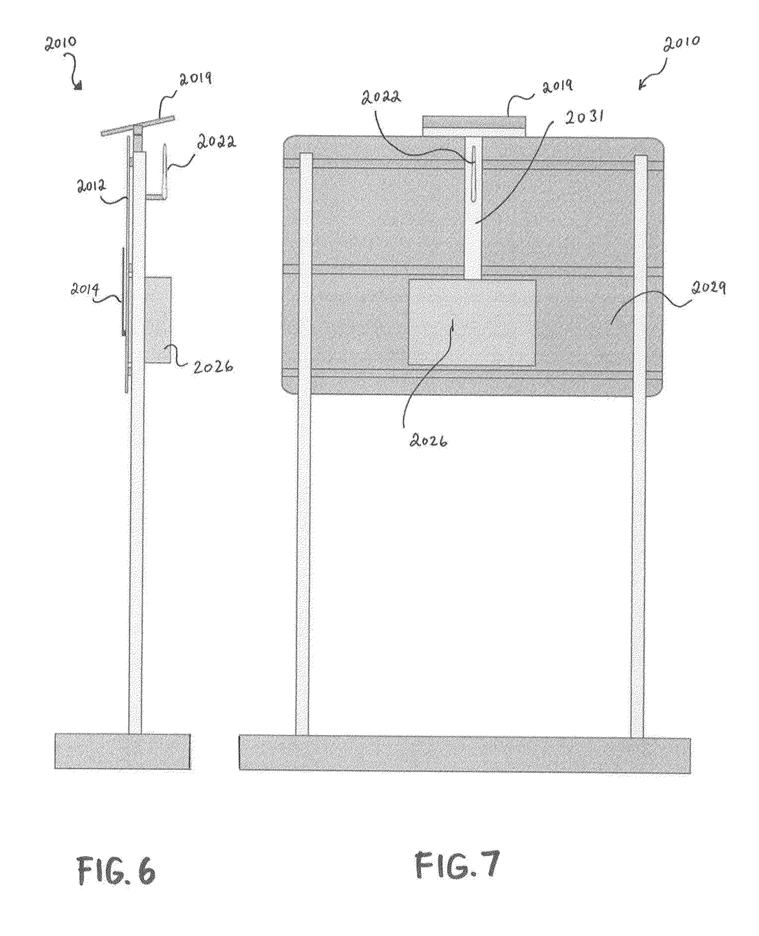

As can be best seen in FIGS. 6 & 7, control box 2026 is configured to be mounted to the rear surface 2029 of sign 2010 by way of, for example, mounting holes and bolts (both not shown). Although bolts are preferred, it will be appreciated that any suitable means of attaching control box 2026 to the rear surface 2029 of sign 2010 may be used in accordance with the present invention. In use, control box 2026 is carefully attached to the rear surface 2029 of sign 2010 so that each of holes 2027.1 to 2027.6, and 2028, are correctly aligned with the respective holes (not shown) provided on display surface 2012 of sign 2010.

Once correctly aligned and attached to sign 2010, proximity sensors 2017.1 to 2017.6 are mounted to holes 2027.1 to 2027.6 of control box 2016, and the respective holes (not shown) of display surface 2012 of sign 2010. Proximity sensors 2017.1 to 2017.6 preferably protrude through display surface 2012 to ensure that the position of needle 2014 relative to the scale segments (not shown) is readily ascertained. Similarly, when attached to sign 2010, a drive shaft (not shown) of a the motor (not shown) used to rotate needle 2014 protrudes through hole 2028 of control box 2026 and through the respective hole (not shown) provided on display surface 2012 of sign 2010. The motor may be preinstalled within control box 2026 or may be installed after attachment of control box 2026 to sign 2010. In any case, once installed the motor drive shaft protrudes through display surface 2012 of sign 2010 enabling needle 2014 to be affixed thereto.

Provided on an upper surface 2026b of control box 2026 is an upwardly projecting pipe or conduit 2030 for receipt of electrical wiring (not shown) that is used to interconnect a photovoltaic panel 2019 and an aerial 2022 of the preferred kit of FIGS. 5 to 7 with internal control modules/components (i.e. the charge controller and remote device manager, respectively—referring back to FIG. 2) housed within control box 2026. To conceal pipe or conduit 2030, and the electrical wiring (not shown), the kit may also include a cover 2031 which may also serve as a mount for aerial 2022 as shown in FIGS. 6 & 7.

When assembled utilising the preferred kit of the present invention, it will be readily apparent that sign 2010 of FIGS. 6 & 7 (whether it be a converted existing manual sign, or a new standalone automated sign) functions in the same manner as that of sign 10 of FIGS. 1 to 3. Although not shown, sign 2010 of FIGS. 5 to 7 may include some or all of the optional devices (20, 20a) of sign 10 of FIGS. 1 to 3. For example, although not shown in FIGS. 5 to 7, if required the control box 2026 of the preferred kit of the present invention could be configured to provide an optional LED display to the assembled sign 2010. That is, a viewing window could be provided on display surface 2012 of sign 2010 (for example, in FIG. 4, relative to where a display board(s) 1024 would normally be affixed to a manual sign 1010), which is aligned with an LED display provided on control box 2026. Similarly, the preferred kit of the present invention could also be provided with additional lighting components (20a in FIGS. 2 & 3) as required in order to illuminate sign 2010.

It will be appreciated that in situations where existing manual signs vary, the control box 2026 and/or other components of the preferred kit may need to be altered to suit those varying signs. It is therefore envisaged that a series of such kits will be provided in order to suit a range of existing manual signs 1010. The present invention should therefore not be construed as limited to the specific examples provided in the drawings.

In an alternative embodiment, not shown, a kit made in accordance with a preferred embodiment of the present invention may be provided without an indicator needle. Here, instead of providing proximity sensors in holes 2027.1 to 2027.6 of control box 2026, a series of coloured high intensity LED lights (which could be the same or similar to lights 18.1 to 18.6 described with reference to sign 10 of FIGS. 1 to 3) could be provided for illuminating respective scale segments of sign 2010. In such an alternative embodiment, feedback to server computer system 110 and/or client computer system 120, could be provided by detecting whether there is resistance on the light circuit relative to the high intensity LED light that is intended to be illuminated. That is, should server computer system 110 send commands to sign 2010 to illuminate a respective scale segment, and the high intensity LED light relative to that segment fail to illuminate, the control means of the sign 2010 will be able to detect the failure by way of there being no resistance on the light circuit. A skilled person will appreciate this and further alternative embodiments. Accordingly, the present invention should be construed as including within its scope any suitable alternative embodiments that would be deemed appropriate by the skilled person.

While this invention has been described in connection with specific embodiments thereof, it will be understood that it is capable of further modification(s). The present invention is intended to cover any variations, uses or adaptations of the invention following in general, the principles of the invention and including such departures from the present disclosure as come within known or customary practice within the art to which the invention pertains and as may be applied to the essential features hereinbefore set forth.

As the present invention may be embodied in several forms without departing from the spirit of the essential characteristics of the invention, it should be understood that the above described embodiments are not to limit the present invention unless otherwise specified, but rather should be construed broadly within the spirit and scope of the invention as defined in the attached claims. Various modifications and equivalent arrangements are intended to be included within the spirit and scope of the invention. Therefore, the specific embodiments are to be understood to be illustrative of the many ways in which the principles of the present invention may be practiced.

Throughout this specification, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as, an acknowledgment or any form of suggestion that the prior publication (or information derived from it) or known matter forms part of the common general knowledge in the United States, Australia or elsewhere.

1. A sign for display of an environmental condition, including:
a display portion including a front display surface having at least one scale indicating levels of the environmental condition;
at least one indicator which is movable over the at least one scale to provide a visual indication of a predetermined level of the environmental condition; and,
a control means affixed to a rear surface of the display portion for moving the at least one indicator over the at least one scale;
wherein the control means includes a remote device management module which is controllable from a remote location over a communications network to move the at least one indicator to the predetermined level.

2. The sign according to claim 1, wherein the at least one scale is an ordinal scale represented by a plurality of areas on the front display surface of the display portion, each area corresponding to one of the levels of the environmental condition.

3. The sign according to claim 2, wherein the areas are segments of a semicircle.

4. The sign according to claim 3, wherein the segments are coloured.

5. The sign according to claim 1, wherein the at least one indicator is at least one needle, and wherein the at least one needle is rotatable about an axis perpendicular to a plane of the sign.

6. The sign according to claim 5, wherein the, or each, needle is drivable by an electric motor, and wherein the control means includes drive means for driving the electric motor.

7. The sign according to claim 1, wherein the control means includes a programmable logic controller operably coupled to the remote device management module.

8. The sign according to claim 2, further including a plurality of proximity sensors or switches, each proximity sensor being associated with one of the plurality of areas, wherein the plurality of proximity sensors are used to determine the position of the at least one indicator.

9. The sign according to claim 1, wherein the environmental condition is a fire danger rating.

10. The sign according to claim 1, further including an independent power supply.

11. The sign according to claim 10, wherein the independent power supply includes at least one photovoltaic panel and/or at least one wind turbine.

12. The sign according to claim 1, further including at least one electronic display means operably coupled to the control means, wherein the at least one electronic display means is configured to display data received over the communications network.

13. A system for display of an environmental condition, including:
a computer system configured to connect to a communications network;
computer-readable data storage in communication with the computer system; and,
at least one sign according to any one of the preceding claims;
wherein the computer-readable data storage includes computer-readable instructions stored thereon which, when executed, cause the computer system to perform the steps of, for the or each said sign:
receiving data representative of a predetermined level of the environmental condition;
transmitting, over the communications network, instructions to the remote device management module to move the at least one indicator to the predetermined level.

14. A kit for converting a manual sign for display of an environmental condition to an automated sign for display of an environmental condition, the manual sign including a display portion having a front display surface with at least one scale thereon indicating levels of the environmental condition, the kit including:
control means for affixing to a rear surface of the display portion of the manual sign; and,
at least one indicator to be coupled to the control means through the display portion, the at least one indicator being movable over the at least one scale to provide a visual indication of a predetermined level of the environmental condition;
wherein the control means includes a remote device management module which is controllable from a remote location over a communications network to move the at least one indicator to the predetermined level.

15. The kit according to claim 14, wherein the at least one indicator is at least one needle, and wherein the at least one needle is rotatable about an axis perpendicular to a plane of the sign.

16. The kit according to claim 15, wherein the, or each, needle is drivable by an electric motor, and wherein the control means includes drive means for driving the electric motor and a programmable logic controller operably coupled to the remote device management module for controlling the drive means.

17. The kit according to claim 14, further including a plurality of proximity sensors or switches used to determine the position of the at least one indicator.

18. The kit according to claim 14, wherein the environmental condition is a fire danger rating.

19. The kit according to claim 14, further including an independent power supply.

20. The kit according to claim 19, wherein the independent power supply includes at least one photovoltaic panel and/or at least one wind turbine.
